(19) United States
(12) Patent Application Publication
(10) Pub. No.: US 2018/0353925 A1
(43) Pub. Date: Dec. 13, 2018

(54) METHOD AND SYSTEM OF AUTOMATED DETERMINATION OF THE OPTIMAL VALUES OF CHEMICAL TECHNOLOGY SYSTEM'S FUNCTIONING PARAMETERS IN REAL TIME MODE

(71) Applicant: CHEMICAL TECHNOLOGIES, INC., Wilmington, DE (US)

(72) Inventors: Oleg Valeryevich GIIAZOV, Saint-Petersburg (RU); Artem Anatolevich ERMULIN, Nurlat (RU)

(21) Appl. No.: 16/005,019

(22) Filed: Jun. 11, 2018

Related U.S. Application Data
(60) Provisional application No. 62/518,143, filed on Jun. 12, 2017.

(51) Int. Cl. B01J 19/00; G06F 19/00; C10G 7/12

(52) U.S. Cl. CPC B01J 19/0033; G06F 19/702; C10G 7/12; B01J 2219/00243; B01J 2219/00186; B01J 2219/00229; B01J 2219/00162; B01J 2219/00051; B01J 2219/00195

(57) ABSTRACT

The system and method of automated determination of the optimal parameters' values of chemical technology system (CTS) functioning in real time mode. The technical result of CTS optimization consists in determining the optimal values of CTS parameters in real time mode on the basis of the current values of CTS functioning parameters and prediction of the values of CTS functioning parameters through a time interval. The result is achieved by supplementing CTS data array by using a mathematical model, including the thermodynamic process description. On the basis of the obtained data array, a mathematical model is formed, based on a statistical modeling or machine learning, which allows to determine the necessary parameters of CTS in real time mode and the values of CTS parameters through a time interval. Based on CTS description in real time mode and the prediction of CTS state through a time interval, the optimal values of CTS functioning parameters in real time mode are determined.

### CROSS-CLAIM TO A RELATED APPLICATION

This application claims priority to an earlier filed U.S. provisional patent application Ser. No. 62/518,143 filed on Jun. 12, 2017, which provisional application is incorporated herein by reference in its entirety.

### FIELD OF THE INVENTION

The invention relates to the automated determination of the optimal values of continuous chemical technology system's functioning parameters in real time mode, as well as to the components used in the oil refining, petrochemical, chemical and fertilizer industries.

### BACKGROUND OF THE INVENTION

This invention relates to the optimization of chemical technology system (CTS) functioning, particularly to the system and method of automated determination of the optimal values of CTS functioning parameters in real time mode. Determination of the optimal values of CTS functioning parameters in real time mode both significantly increases productivity and significantly reduces lost production and energy costs.

### SUMMARY OF THE INVENTION

In general, CTS includes an aggregate of technological equipment or technological units directly involved in the technological process. The determination of the performance parameters of a technological unit of CTS is possible, including, but not limited to, on the basis of pressure parameters, temperature parameters, flow parameters and the composition of CTS process flows. The parameters include physical and chemical parameters of the process conditions, information on the composition of the main and auxiliary process flows, environmental parameters including ambient parameters, administrative-and-managerial and planning and economic indicators, and also possible consolidated and combined values.

The sources of data may be, but are not limited to, the following list: primary and secondary measuring instruments and sensors, information provided by process analyzers installed directly within CTS, and by an external laboratory, any sources of information on environmental parameters, administrative-and-managerial and planning and economic indicators.

For further processing of CTS data in order to optimize CTS functioning, their profound preparation and processing is required, implemented using an automated algorithm. The technical result of CTS optimization consists in determining the optimal values of CTS parameters in real time mode on the basis of the current values of CTS functioning parameters and prediction of the values of CTS functioning parameters after a time interval. The result is achieved by supplementing CTS array of data with the necessary values of CTS parameters using a mathematical model based on the physic-chemical description of the process, including the thermodynamic description of the process (a thermodynamic model). On the basis of the obtained array of data a mathematical model is formed based on statistical modeling or machine learning (a statistical model), which allows determination of the necessary parameters of CTS in real time and the values of CTS parameters after a time interval. Based on CTS description in real time and the prediction of CTS state after a time interval, the optimal values of CTS functioning parameters in real time mode are determined.

### BRIEF DESCRIPTION OF THE DRAWINGS

FIG. 1—Block diagram of the method and system of automated determination of the optimal values of chemical technology system's functioning parameters in real time mode

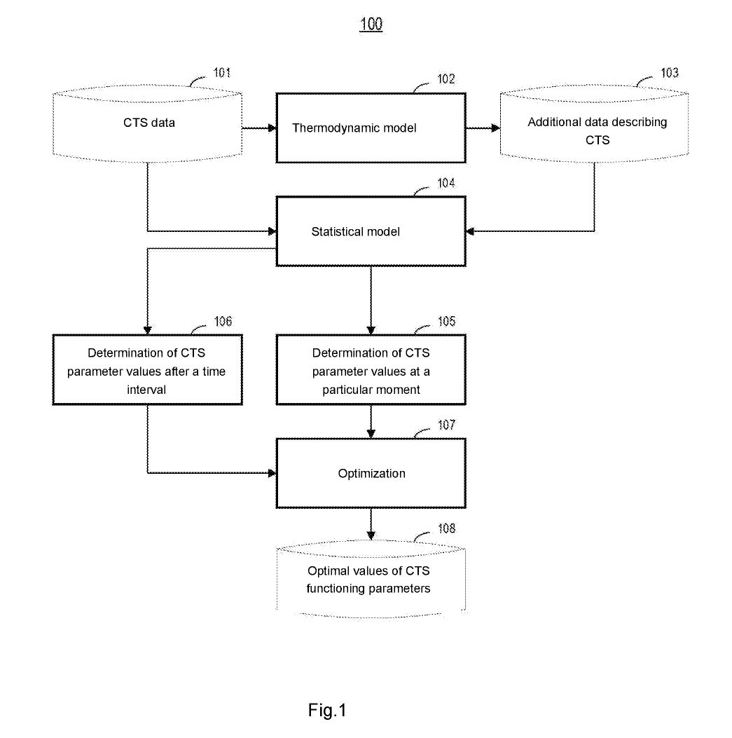

FIG. 2—Schematic diagram of the process rectification unit

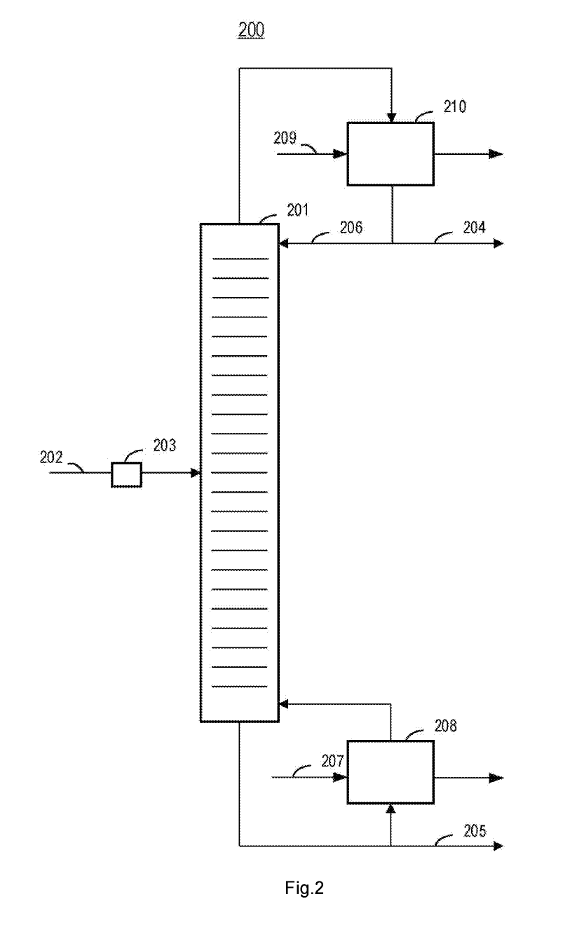

### DETAILED DESCRIPTION OF THE PREFERRED EMBODIMENTS

Method and system 100 begins in unit 101, which is an array of CTS data. CTS data are, as a rule, including, but not limited to, CTS parameter values coming from primary and secondary measuring instruments, sensors, analyzers, automatic process control system in general, etc.

To describe the current CTS state and the prediction of CTS state for the purpose of further optimization of CTS functioning in real time mode, the above data are not sufficient, for they are limited by the measuring instruments comprised in CTS and by the instrumentation in general for the physical or analytical determination of CTS parameter values. At the same time, even if it is possible to determine the value of CTS parameter, there is a limit, as a rule, of discreteness and frequency of its determination.

To supplement data from CTS with the necessary data for further optimization of its functioning, as well as to supplement data with insufficient time discreteness, on the basis of array 101, the parameters in unit 102 are determined.

As unit 102, any methods, algorithms, thermodynamic models, specialized software that allow the values of the process parameters of CTS operation to be calculated using a thermodynamic description of the process to the specified accuracy can be used. The result of the calculation of stage 102 is an array of parameter values 103 supplementing the original array of data 101 with the values of missing CTS parameters necessary for further optimization of CTS functioning, and of CTS parameter values with the required time discreteness. Thus, units 101 and 103 form an array of data that can be efficiently processed by various statistical methods.

On the basis of the dependencies in arrays 101 and 103, a statistical model is compiled in unit 104, which represents, as a rule, a system of equations describing the dependencies between CTS parameters. As a result, the statistical model in unit 104 based on the dependencies between CTS parameters is able to determine the values of the necessary parameters with the necessary time discreteness for the purpose of further optimization of CTS functioning, based on the values of CTS parameters to be measured in real time mode.

In unit 105 the statistical model formed in unit 104 on the basis of data obtained from CTS, including but not limited to the primary and secondary measuring instruments, sensors, analyzers, automated process control system in general, etc., supplements them with values of CTS functioning parameters, which describe CTS thermodynamic state at a particular moment, and also supplements with data that cannot be obtained from outside, including but not limited to the primary and secondary measuring instruments, sensors, analyzers, automated process control system in general, etc. at a particular moment. Based on the value of CTS parameter or a combination of CTS parameters at a particular moment, it is possible to determine to the specified accuracy the value of CTS parameter, which is not determined by a physical device, sensor, analyzer or any other instrumentation known to a specialist in the industry. This method can be illustrated, including but not limited to, by an example where, based on the consumption rate of one of the process flows, the temperature of another process flow and/or the temperature inside the process apparatus, measured by measuring instruments, the composition of another process flow at a particular moment is determined to the specified accuracy.

Similarly, in unit 105 it is possible to determine any necessary values of CTS parameters at a particular moment regardless of the ways and methods for determining them: using physical instrumentation, including measuring instruments, sensors, analyzers, automated process control system in general etc. or using their determination by a statistical model. Thus, the statistical model in unit 105 generates a description of CTS current state at a particular moment.

In unit 106 the statistical model formed in unit 104 on the basis of data currently obtained from CTS, including but not limited to the primary and secondary measuring instruments, sensors, analyzers, automated process control system in general etc., determines to the specified accuracy the value of CTS parameter after a time interval; as a rule this interval depends on the discreteness of determining the current values of CTS parameters in unit 105, however, as a rule, it can be a time interval from several minutes to several hours. The data determined after a time interval do not depend on the ways and methods of determining the values of CTS parameters in real time: using physical instrumentation, including measuring instruments, sensors, analyzers, automated process control system in general etc. or using their determination by a statistical model. Thus, in unit 106 the prediction of the necessary CTS parameter values is formed to the specified accuracy after a time interval. This method can be illustrated, including but not limited to, by an example where, based on the consumption rate of one of the process flows, the temperature of another process flow and/or the temperature inside the process apparatus, measured by measuring instruments in real time, the composition of another process flow is determined to the specified accuracy 30 minutes after the current time, or by an example where, based on the composition of the process flow at a particular moment, the composition of said process flow after 45 minutes from the current time is determined.

The application of the described method in units 105 and 106 of determining CTS current state and the prediction of CTS state after a time interval allows the necessary and sufficient parameters of CTS value, with a discreteness of several minutes or less, to be obtained in real time within the minimum time in order to further optimize CTS functioning.

On the basis of the necessary and sufficient CTS description at a particular moment and the prediction of CTS state after a time interval, optimization unit 107 based on the thermodynamic model of CTS functioning determines the most optimal CTS functioning values. The optimal values of CTS functioning are determined from the specified optimization criteria, such as, including but not limited to, the minimum energy consumption per ton of products, the maximum CTS productivity by the target product, the minimum production of by-products, the minimum losses of production, etc.

The optimal values of CTS functioning parameters in real time come from unit 107 to array of data 108. The result is displayed as a human-machine interface, or directly to CTS automation system.

### Version of an Embodiment of this Invention

One of the embodiments of this invention optimizes the functioning of CTS which is rectification unit 201 of separation of a hydrocarbon fraction containing propane, iso-butane, n-butane, iso-pentane, with measurements of consumptions of process flows, pressures of process flows and in processing units, temperatures of process flows and in processing units, the composition of the supply stream. Moreover, the composition of supply stream 202 is determined by on-stream chromatographic analyzer 203 with work cycle of 40 minutes and with iso-pentane being a measured component in supply stream 202. The composition values of supply stream 202 of process rectification unit 200 are not complete enough to optimize CTS functioning. In particular, for further efficient process optimization of CTS it is necessary to determine the contents of all components in supply stream 202, namely, propane, iso-butane, n-butane, iso-pentane with discreteness of one minute. To supplement the contents of the components iso-butane, n-butane and the contents of iso-pentane with the specified discreteness of one minute, thermodynamic model 102, based on array 101 of the performance parameters of rectification unit 200, calculates the composition of supply stream 202 of process rectification unit 200 with the contents of the components propane, iso-butane, n-butane and iso-pentane with discreteness of one minute. On the basis of original array 101 with the supplemented values from thermodynamic model 103, statistical model 104 is created that takes into account the interactions between the parameters of process rectification unit 200. Statistical model 105 formed in unit 104, on the basis of the consumptions of product flows 204, 205 of process rectification unit 200 and the temperatures on the contact devices inside the rectification column at a particular moment determines the content of propane, iso-butane, n-butane and iso-pentane in the composition of the supply stream of the process rectification unit at a particular moment to the specified accuracy and discreteness of one minute, which together with array 101 is the necessary and sufficient description of CTS functioning at a particular moment. Using statistical prediction methods, statistical model 106 formed in unit 104 determines the change in the contents of the components propane, iso-butane, n-butane and iso-pentane components in the supply stream of the process rectification unit after a time interval of 40 minutes. On the basis of the necessary and sufficient description of CTS 105 with the predicted change in the contents of the components in supply stream 202 of process rectification unit 200 the most optimal consumptions of reflux flow 206 of rectification column 201, the consumption of heat-transfer agent 207 into reboiler 208, and the temperature of reflux flow 206 by the consumption of coolant 209 into condenser 210 of process rectification unit 200 are determined in order to increase the productivity of process rectification unit 200 by supply (202) and product (204, 205) flows and reduce energy consumption per ton of production.

The authors of this invention surprisingly found that with the use of this method and system, units 101-104 may be executed with considerably less frequency than units 105-108 to achieve an equivalent result when all units 101-108 are executed with the same frequency in real time mode. Thus, in particular, it was found that the execution of units 101-104 once a month or once a year can be performed with the execution of units 105-108 with the frequency of once per minute when an equivalent result is reached when all units 101-108 are executed with the frequency of once per minute.

The authors of this invention surprisingly found that during operation of the described system by a highly qualified specialist and/or a group of specialists in the industry having specialized professional experience, the result of CTS optimization is comparable or identical to the operation of the described system and the method of CTS optimization by a specialist not having a high qualification in the industry and specialized professional experience. On the basis of this unexpected discovery a conclusion was made that qualification of the specialist, number of specialists and their professional experience in the industry do not have a significant effect on the efficiency of the proposed method and system.

What is claimed is:

1. The system of automated determination of the optimal values of chemical technology system functioning parameters in real time mode which includes chemical technology system's data, a thermodynamic model for supplementing chemical technology system's data with missing values, a statistical model the formation of which determines the values of chemical technology system's parameters at a particular moment the values of chemical technology system's parameters after a time interval and an optimization unit calculating the optimal values of chemical technology system's functioning parameters on the basis of the values of chemical technology system's parameters at a particular moment and the values of chemical technology system's parameters after a time interval.

2. A system according to cl.1 where the frequency of measurement of the values of chemical technology system's data is within the range from 1 second to 480 seconds, preferably from 20 seconds to 60 seconds.

3. A system according to cl.1 where chemical technology system's data are the values of pressure, temperature, consumption and the compositions parameters.

4. A system according to cl.1 where the thermodynamic model is a strict physical and chemical model of oil and gas treatment processes or a model, describing the functioning of process equipment.

5. A system according to cl.1 where the time interval for calculating predicted values is within the range from 5 minutes to 480 minutes, preferably from 10 minutes to 80 minutes.

6. A system according to cl.1 where the task of optimization unit is a reduction of utilities' consumption, losses, reduction of content of admixtures in product flows and increase of yields of product flows of chemical technology system.

7. A system according to cl.1 where the optimal values of chemical technology system's functioning parameters are pressure, temperature, consumption and composition parameters.
